(19) United States
(12) Patent Application Publication
(10) Pub. No.: US 2015/0088743 A1
(43) Pub. Date: Mar. 26, 2015

(54) SERVER, A TERMINAL APPARATUS, AND A METHOD FOR PROVIDING CARD INFORMATION TRANSMITTING SERVICE

(71) Applicant: KRPartners Co., Ltd., Seoul (KR)

(72) Inventor: Joonhun Kim, Seoul (KR)

(21) Appl. No.: 14/183,762

(22) Filed: Feb. 19, 2014

(30) Foreign Application Priority Data
Sep. 23, 2013 (KR) 10-2013-0112510

(51) Int. Cl. G06Q 20/40; G06Q 20/32

(52) U.S. Cl. CPC G06Q 20/409; G06Q 20/322
USPC 705/44

(57) ABSTRACT

Disclosed is a method for providing a card information transmitting service by a terminal apparatus. The method for providing a card information transmitting service includes: when a card transaction is performed in a merchant by using a card registered in a card information transmitting service, receiving location information of the merchant from a card information transmitting service providing server; detecting a notification providing mode set in a terminal apparatus in association with the card information transmitting service; and providing notification by using the location information of the merchant received according to the detected notification providing mode.

### RELATED APPLICATIONS

Under 35 USC 119, this application claims the benefit of the priority date of Korean Patent Application No. 10-2013-0112510, filed Sep. 23, 2013, the contents of which are herein incorporated by reference.

### BACKGROUND OF THE INVENTION

1. Field of the Invention

The present invention relates to a server, a terminal apparatus, and a method for providing a card information transmitting service.

2. Description of the Conventional Art

With rapid development of mobile communication technology and public propagation of communication terminals, most people possess and use communication terminals that execute multi-functions now. The multi-functional communication terminals have been extended to multimedia terminals that can perform digital camera photographing or play MP3 music files in terms of their functions in addition to a voice communication function which is an original function of a telephone and provided various additional services.

For this, in recent years, smart phones having functions by combining the function of the communication terminal and a function of a personal digital assistant (PDA) have attracted public attention. The smart phone as an intelligent terminal additionally having computer supporting functions such as Internet communication and information searching in addition to a cellar phone is installed with a large-capacity memory and a high-performance central processing unit (CPU), and installed with an operating system (OS) for supporting execution of various applications, voice/data communication, and personal computer (PC) interworking. As a result, a user can arbitrarily use the Internet through the smart phone unlike the existing communication terminal. Further, a credit card company periodically advances various advertisements and free gift events in order to promote user's consumption through the smart phone.

However, in general, messages of the credit card company primary include a card approval message or a simple advertisement message, and there is no information so as for a credit card user to substantially use. Further, even in the case of the credit card approval message, since there is no additional information in addition to information indicating that a predetermined amount of money is approved with respect to any store, the credit card approval message may be classified into spam.

Further, since an approval message sent by the credit card company includes only limited information, the user need not check the approval message. In comparison with the trend of a current rapid increase in amount of a credit card used, only the amount of data which is unnecessarily transmitted and received has increased and the necessity of a card information providing method capable of the data amount comes to the fore.

### SUMMARY OF THE INVENTION

The present invention has been made in an effort to provide a method for providing a card information transmitting service that can transmit card information including card use location information through various notification methods.

The present invention has also been made in an effort to provide a method for providing a card information transmitting service that enables using and promoting various services which interwork with transmission of card information as a user verifies a card information message.

An exemplary embodiment of the present invention provides a method for providing a card information transmitting service by a server, including: receiving a card information transmitting service registration request of a customer; registering card information transmitting service requested card included in the request and identification information of the customer; receiving, when card identification information included in transaction information by a card transaction in a merchant matches the card information transmitting servicer request card information, identification information of the merchant and the card identification information from a relay server that relays an approval response to the card transaction; and transmitting merchant location information corresponding to the merchant identification information to a terminal apparatus of the customer by using customer identification information corresponding to the received card identification information.

Meanwhile, another exemplary embodiment of the present invention provides a method for providing a card information transmitting service by a terminal apparatus, including: receiving, when a card transaction is made in a merchant by using a card registered in the card information transmitting service, card information including location information of the merchant from the card information transmitting service providing server; detecting a notification providing mode set in the terminal apparatus in association with the card information transmitting service; and providing notification by using the received card information according to the detected notification providing mode.

Meanwhile, yet another exemplary embodiment of the present invention provides a server for providing a card information transmitting service, including: a communication unit receiving a card information transmitting service registration request of a customer; a storage unit registering card information of a transmitting service requested card included in the request and identification information of the customer; and a control unit receiving, when card information included in transaction information by a card transaction in a merchant matches card information transmitting servicer request card information, identification information of the merchant and the card identification information from a relay server that relays an approval response to the card transaction, and controlling the communication unit so as to transmit location information of the merchant corresponding to the received identification information of the merchant to a terminal apparatus of the customer by using customer identification information corresponding to the received card information.

Meanwhile, still another exemplary embodiment of the present invention provides a terminal apparatus for providing a card information transmitting service, including: a communication unit receiving, when a card transaction is made in a merchant by using a card registered in the card information transmitting service, card information including location information of the merchant from the card information transmitting service providing server; a detection unit detecting a notification providing mode set in the terminal apparatus in association with the card information transmitting service; and a control unit providing notification by using the received location information of the merchant according to the detected notification providing mode.

According to aforementioned various exemplary embodiments of the present invention, various services based on card information including location information of a user and card usage location information can be provided by providing notification associated with a card information transmitting service to a terminal apparatus.

Further, only when a predetermined condition is met, the terminal apparatus provides the notification associated with the card information transmitting service to remove spam notification.

According to the exemplary embodiment of the present invention, the card information may include a phone number, the amount of money, an item, an event, a reserved point detail, an advertisement, and the like according to the user set-up and the card company may acquire feedbacks such as stamp quantity designation issuing such as a giveaway, an event, and the like depending on the transaction debit, transmission of survey information, and marketing information such as a settled product, thereby providing more plentiful card usage services.

Further, according to the exemplary embodiment of the present invention, the user may verify a message when location information of the merchant and card usage information reach a terminal of the user. As a result, the user terminal verifies a variety of card information for a corresponding transaction, and transmits information regarding the verification to a card information transmitting service providing server or a card company approval server, and as a result, a card company can easily record a message verification detail, estimate an advertisement effect, and estimate expense.

According to various exemplary embodiments of the present invention, the card information transmitting service providing server receives location information of a merchant which is transmitted among a card acquirer server, a relay server, and a card issuer server in the related art through the relay server to maintain an existing infrastructure as it is.

### BRIEF DESCRIPTION OF THE DRAWING

FIG. 1 is a block diagram illustrating a system for providing a card information transmitting service according to an exemplary embodiment of the present invention.

FIG. 2 is a timing diagram illustrating a registering operation in the card information transmitting service according to the exemplary embodiment of the present invention.

FIG. 3 is a timing diagram illustrating a case in which transaction is performed by using a card according to the exemplary embodiment of the present invention.

FIG. 4 is a block diagram illustrating a server for providing a card information transmitting service according to the exemplary embodiment of the present invention.

FIG. 5 is a flowchart, in detail, illustrating a method for providing a card information transmitting service according to an exemplary embodiment of the present invention.

FIG. 6 is a block diagram illustrating a terminal apparatus according to the exemplary embodiment of the present invention.

FIG. 7 is a flowchart, in detail, illustrating a method for providing a card information transmitting service of the terminal apparatus according to the exemplary embodiment of the present invention.

### DETAILED DESCRIPTION OF THE PREFERRED EMBODIMENT

The following description illustrates only a principle of the present invention. Therefore, those skilled in the art may implement the principle of the invention and create various devices within a concept and a scope of the invention even though not clearly described or illustrated in the specification. It should be further understood that all conditional terms and exemplary embodiments which are described in the specification are intended to understand the concept of the invention but the present invention is not limited to the exemplary embodiments and states specifically described in the specification.

Further, it is also understood that all detailed description which specifies not only a principle, an aspect, and an exemplary embodiment of the present invention, but also a specific embodiment is intended to include structural and functional equivalents thereof. Further, it is understood that such equivalents include all elements which are invented so as to perform the same function as the currently disclosed equivalents and equivalents which will be developed in the future regardless of the structure.

Therefore, for example, the block diagram of this specification is understood to represent a conceptual aspect of an illustrative circuit which specifies the principle of the invention. Similarly, it should be understood that all of a flowchart, a status transitional view, and a pseudo code are substantially represented in a computer readable medium and indicate various processes executed by a computer or a processor regardless of whether a computer or a processor is apparently illustrated.

Functions of various elements illustrated in the drawings including a functional block which is represented by a processor or a similar concept may be provided by using not only exclusive hardware but also hardware which may execute software with regard to appropriate software. If the function is provided by the processor, the function may be provided by a single exclusive processor, a single shared processor or a plurality of individual processors and some of them may be shared.

Further, a precise usage of a processor, control or a terminology suggested as a similar concept thereto cannot be interpreted by exclusively citing hardware which is capable of executing software but should be understood to implicatively include digital signal processer (DSP), a ROM, a RAM, and a nonvolatile memory which store hardware and software without any restrictions. Widely known and commonly used other hardware may be included thereto.

In claims of this specification, components represented as means to perform the function described in the detailed description, for example, are intended to include a combination of circuit elements which perform the above-mentioned functions or all methods which perform functions including all types of software including a firmware/microcode and combined with an appropriate circuit which executes the software in order to perform the function. In the invention defined by the claims, the functions provided by the various described means are combined with each other and also combined with the method demanded by the claims so that any means which provides the above-mentioned function is understood to be equivalent as understood from the specification.

The above objects, features, and advantages will be more obvious from the detailed description with reference to the accompanying drawings, and the technical spirit of the present invention may be easily carried out by those skilled in the art. In the following description, a detailed explanation of known related functions and constitutions may be omitted so as to avoid unnecessarily obscuring the subject matter of the present invention.

Hereinafter, various exemplary embodiments of the present invention will be described in detail with reference to the accompanying drawings.

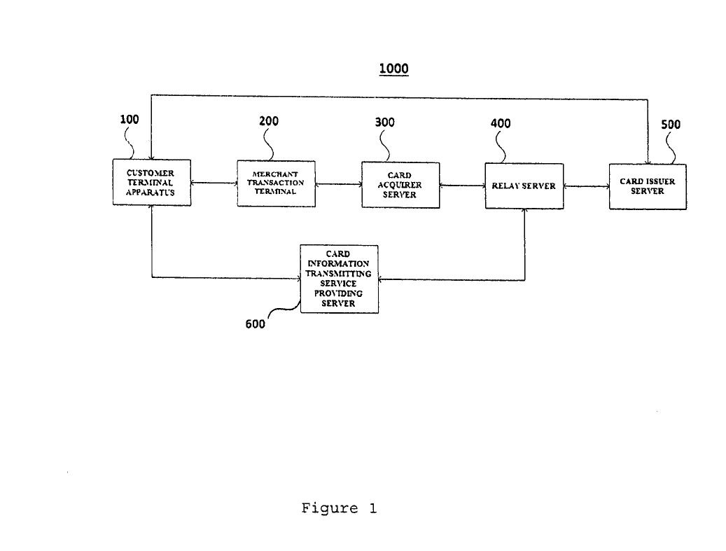

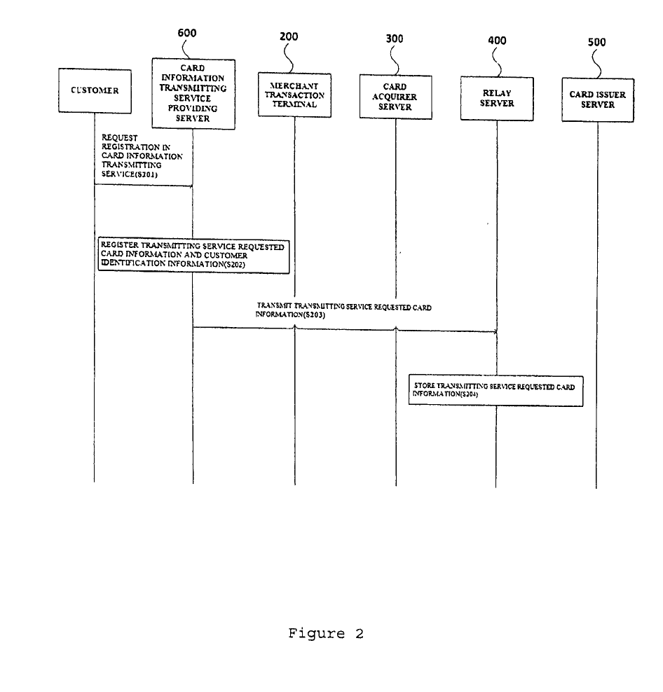

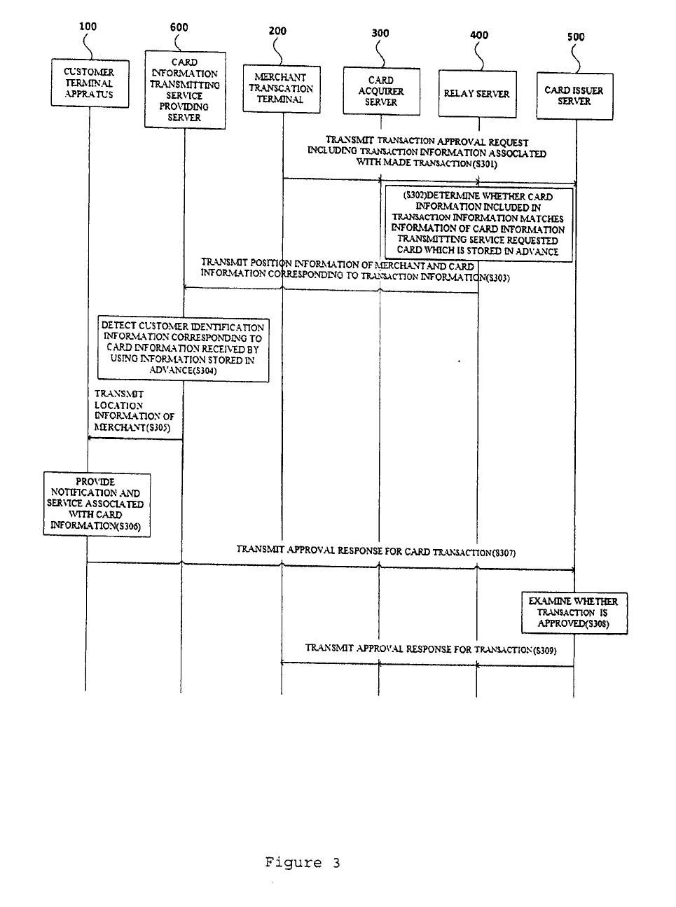

FIG. 1 is a block diagram illustrating a system for providing a card information transmitting service according to an exemplary embodiment of the present invention. Referring to FIG. 1, the card information transmitting service providing system 1000 includes all or some of a customer terminal apparatus 100, a merchant transaction terminal 200, a card acquirer server 300, a relay server 400, a card issuer server 500, and a card information transmitting service providing server 600. FIG. 2 is a timing diagram illustrating a registering operation in the card information transmitting service according to the exemplary embodiment of the present invention. FIG. 3 is a timing diagram illustrating a case in which transaction is performed by using a card according to the exemplary embodiment of the present invention.

The customer terminal apparatus 100 communicates with the card information transmitting service providing server 600 to provide the card information transmitting service to a customer that is registered in the card information transmitting service. Herein, the customer terminal apparatus 100 may be implemented by various apparatuses such as a mobile device, a smart phone, a tablet computer, a notebook computer, a personal digital assistant (PDA), a portable multimedia player (PMP), a digital TV, a wearable smart glass, a wearable smart watch, and the like.

Further, the merchant transaction terminal 200 is provided in a merchant that sells ‘a product or a service’ (hereinafter, generally referred to as a product) online or offline to accept an order for the product and a transaction request for the product from the customer. Herein, the merchant transaction terminal 200 may be implemented by a point of sale (POS) or a card read terminal in the case of offline sales.

Further, the card issuer may be a subject that issues a card to the customer, examines approval of transaction of the customer, demands and receives a card payment to and from the customer, and the card issuer server 500 may be a server provided by the card issuer.

Further, the card acquirer may be a subject that buys a statement of the merchant and makes a card payment of the customer in the merchant, and the card acquirer server 300 may be a server provided by the card acquirer.

In addition, the relay server 400 may be a server provided by a card association (for example, Visa/MasterCard).

Hereinafter, referring to FIGS. 1 to 3, an operation of the card information transmitting service providing system will be described in detail for each of ‘a case of registration in the card information transmitting service’ and ‘a case of making a transaction by using the card’.

<Case of Registration in Card Information Transmitting Service>

First, the customer may request registration in the card information transmitting service to the card information service providing server 600 (S201). Herein, the registration request may be performed in such a manner that the customer accesses a website provided by the card information transmitting service providing server 600 by using the customer's own terminal apparatus 100 to input information of a card information transmitting service requesting card and identification information of the customer. Alternatively, the registration request may be performed in such manner that the customer a card information transmitting service application which interworks with the card information transmitting service providing server 600 by using the customer's own terminal apparatus 100 and inputs the information of the card information transmitting service requested card and the identification information of the customer on the executed application.

Herein, the information of the card information transmitting service requested card may be information to identify a plurality of cards, such as number information of a card that requests the card information transmitting service.

Further, the customer identification information may be information to identify the customer from other customers, such as a phone number of a customer's cellar phone, a serial number of a card information transmitting service providing application installed in the terminal apparatus to the customer, and the like.

In this case, the card information transmitting service providing server 600 maps the card information of the transmitting service requested card, received according to the registration request of the card information transmitting service and the identification information of the customer corresponding thereto to register the mapped information (S202).

In addition, the card information transmitting service providing server 600 may transmit the registered card information of the transmitting service requested card to the relay server (S203).

In this case, the relay server 400 may store the card information of the transmitting service requested card received from the card information transmitting service providing server 600 (S204).

<Case of Making Transaction by Using Card>

Meanwhile, one of a plurality of customers may purchase the product in the merchant and make a transaction by using his/her own card.

Herein, the transaction may be made by using various cards such as a real card, an application type app. card using the terminal apparatus, a card using a USIM (universal subscriber identity module) of the terminal apparatus, and the like.

Further, herein, the card possessed by one of the plurality of customers may be a card issued under the name of the customer from the card issuer or a card acquired from other people due to other people's losing the card.

Meanwhile, when the transaction using the card is made, the merchant transaction terminal 200 may transmit a transaction approval request including transaction information associated with the made transaction to the card issuer server 500 through the card acquirer server 300 and the relay server 400 (S301).

Herein, transaction information may include transaction amount information for the product bought by the customer, identification information of the merchant where the customer buys the product, and identification information of the card which the customer uses at the time of settling the bought product.

Meanwhile, the relay server 400 may determine whether the card identification information included in the transaction information matches the card information of the transmitting service requested card, in advanced, stored in step S204 (S302).

If both information matches each other, the relay server 400 may transmit the identification information of the merchant and the card identification information included in the transaction information to the card information transmitting service providing server 600 (S303).

In this case, the card information transmitting service providing server 600 detects customer identification information corresponding to the card identification information received by using the information stored in step S202 (S304) to transmit card information including merchant location information to the terminal apparatus 100 of the customer (S305).

In particular, in the exemplary embodiment of the present invention, the card information may include the aforementioned merchant location information or usage location information in addition to the conventional transaction amount, transaction time, and merchant identification information.

In addition, a transmission path of the card information may be selected among a plurality of paths. For example, the card information transmitting service providing server 600 may transmit the card information to the terminal apparatus 100 through at least one path of a short message service (SMS) through a mobile communication network, a push service through the mobile communication network or a data transmission network, or an e-mail through the data transmission network. Further, such a transmission method may be decided in advance during the registration of the card information transmitting service of the customer and may be changed according to a user set-up even after the registration.

In this case, the customer terminal apparatus 100 may provide various services which interwork with the card information transmitting service to the customer by using the received card information (S306).

For example, the service which interworks with the card information transmitting service may include a transaction details management service of the terminal apparatus 100.

The terminal apparatus 100 may create transaction details information based on the received card information and display the created transaction details information according to a user input when the transaction detailed management service is executed. For example, the transaction detailed information may include a card debit, a usage position, a transaction date, merchant identification information, merchant location information, and terminal location information. Accordingly, since the user may verify the transaction detailed information including a merchant position and a terminal position by getting out of a limit of a conventional transaction detailed SMS of the card company, the user may definitely may verify a transaction history and improve security.

Further, the service which interworks with the card information transmitting service may include a transaction position display service of the terminal apparatus 100.

The terminal apparatus 100 may create a map image displayed with a transaction position based on the received card information and display the created map image according to the user input when the transaction position display service is executed. For example, the transaction details information may include the merchant location information and the terminal location information. Accordingly, the user may verify the transaction position including the merchant position and the terminal position on the map image. As a result, the user may easily verify a user's own position and a position where the transaction is made while transaction and provide psychological stability to the user.

In addition, the service which interworks with the card information transmitting service may include a card information notification service.

In particular, in step S306, the card information transmitting service providing server 600 may provide card information notification for the notification service, and steps below may be further performed.

The customer may verify the notification and decide whether the transaction is approved through his/her own terminal apparatus 100. When the transaction is approved, the customer terminal apparatus 100 may transmit a transaction approval response to the card issuer server 500 (S307).

Meanwhile, the card issuer server 500 may examine whether the transaction is approved by using the transaction information received from the relay server 400 when the transaction approval response is received from the customer terminal apparatus 100 (S308). As one example, the card issuer server 500 may examine whether the transaction is approved by determining whether a target card is an issued card or is suspended by using the card information included in the transaction information. Meanwhile, the card issuering server 500 may disapprove the transaction when receiving a transaction disapproval response from the customer terminal apparatus 100.

In addition, the card issuer server 500 may transmit an approval response to the merchant-side transaction terminal 200 through the relay server 400, the card acquirer server 300 (S309).

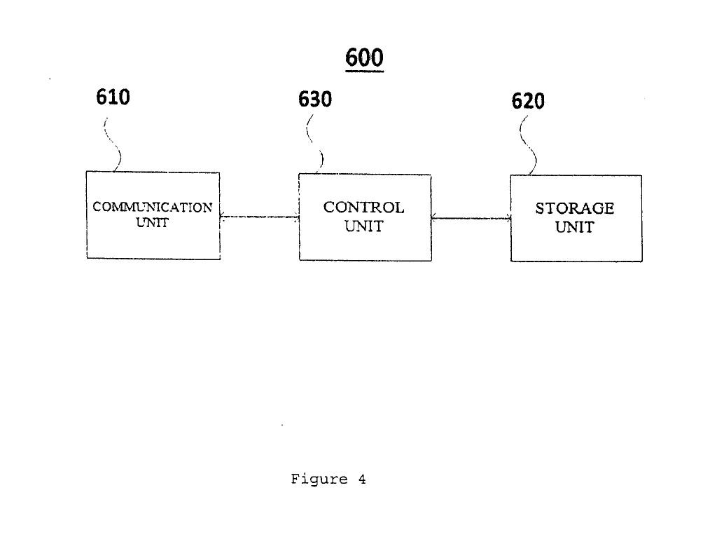

FIG. 4 is a block diagram illustrating a server for providing a card information transmitting service according to the exemplary embodiment of the present invention. Referring to FIG. 4, the card information transmitting service providing server 600 includes all or some of a communication unit 610, a storage unit 620, and a control unit 630.

The communication unit 610 allows the card information transmitting service providing server 600 and an external apparatus to communicate with each other. In particular, the communication unit 610 may receive the case information transmitting service registration request of the customer. Herein, in the card information transmitting service registration request, the information of the card information transmitting service requested card may include the customer identification information.

Herein, the communication unit 610 may adopt a type connected in a wireless or wired method through a local area network (LAN) and the Internet network, a type connected through a universal serial bus (USB) port, a type connected through mobile communication networks such as 3G and 4G, and a type connected through, near field wireless communication methods such as near field communication (NFC), radio frequency identification (RFID), Wi-Fi, and the like.

The storage unit 620 serves to store various data and applications required for an operation of the card information transmitting service providing server 600. In particular, the storage unit 620 may register the information of the card information transmitting service requested card included the card information transmitting service registration request and the customer identification information as illustrated in Table 1 below.

TABLE 1

| Card information | Customer identification | information |
|---|---|---|
| Card number A | Customer cellular phone | number X |
| Card number B | Customer cellular phone | number Y |
| Card number C | Customer cellular phone | number Z |

Herein, the storage unit 620 may be implemented by a storage medium provided in the card information transmitting service providing server 600 or a separate database (DB) connected to the outside so as to communicate with the card information transmitting service providing server 600.

The control unit 630 controls an overall operation of the card information transmitting service providing server 600. In detail, the control unit 630 may control all or some of the communication unit 610 and the storage unit 620.

In particular, the control unit 630 may control the communication unit 610 so as to transmit the information of the card information transmitting service requested card received according to the card information transmitting service registration request to the relay server 400 that relays the approval response to the card transaction between the card acquirer server 300 and the card issuer server 500.

As a result, the relay server 400 may store the card information of the transmitting service requested card received from the card information transmitting service providing server 600.

Herein, the relay server 400 receives the transaction information by the card transaction in the merchant from the card acquirer server 300 to transmit the transaction information to the card issuer server 500.

Further, the relay server 400 determines whether the card identification information included in the transaction information by the card transaction in the merchant matches the previously stored card information transmitting service requested card identification information and when both information matches each other, the relay server 400 may transmit the identification information of the merchant and the card identification information included in the transaction information to the card information transmitting service providing server 600.

In this case, the control unit 630 applies the customer identification information corresponding to the received card identification information to Table 1 stored in the storage unit 620 to detect the customer identification information and may control the communication unit 610 so as to transmit the card information to the terminal apparatus 100 of the customer corresponding to the detected customer identification information.

According to the exemplary embodiment of the present invention, the card information transmitting service is provided among the card acquirer server, the relay server, and the card issuer server based on the merchant identification information which was transmitted in the related art to maintain an existing infrastructure as it is.

According to the exemplary embodiment of the present invention, the card information may include a phone number, the amount of money, an item, an event, a reserved point detail, an advertisement, and the like according to the user set-up and the card company may acquire feedbacks such as stamp quantity designation issuing such as a giveaway, an event, and the like depending on the transaction debit, transmission of survey information, and marketing information such as a settled product, thereby providing more plentiful card usage services.

Further, according to the exemplary embodiment of the present invention, the user may verify a message when location information of the merchant and card usage information reach a terminal of the user. As a result, the user terminal verifies a variety of card usage information for a corresponding transaction and may transmit information associated with the verification to a card information service providing server or a card company approval server. Therefore, estimation of an advertisement effect and estimation of expense may be easily performed.

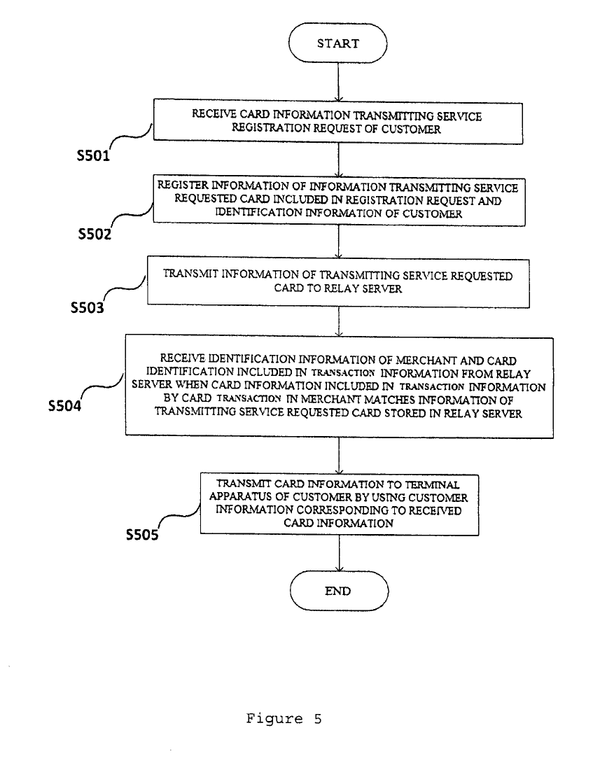

FIG. 5 is a flowchart illustrating a method for providing a card information transmitting service of a server according to an exemplary embodiment of the present invention. Referring to FIG. 5, first, a card information transmitting service registration request of a customer may be received (S501).

In addition, information of a card information transmitting service requested card included in the registration request and identification information of the customer may be registered (S502).

In addition, the information of the card information transmitting service requested card may be transmitted to a relay server that relays an approval response to a card transaction between a card acquirer server and a card issuer server (S503).

Further, when card identification information included in transaction information by the card transaction in a merchant matches the identification information of the card information transmitting service requested card stored in the relay server, identification information of the merchant and the card identification information included in the transaction information may be received from the relay server (S504).

Moreover, card information may be transmitted to a terminal apparatus of a customer by using customer information corresponding to the received card identification information (S505).

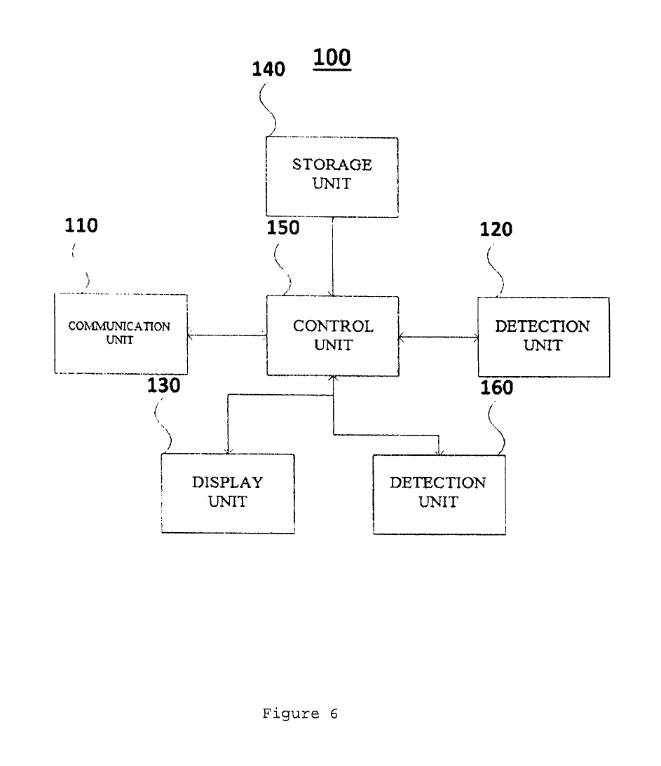

FIG. 6 is a block diagram illustrating a terminal apparatus according to the exemplary embodiment of the present invention. Referring to FIG. 5, a terminal apparatus 100 includes all or some of a communication unit 110, a detection unit 120, a display unit 130, a storage unit 140, a control unit 150, and an input unit 160. Herein, a user of the terminal apparatus 100 may be a use who requests registering his/her own card in a card information transmitting service.

The communication unit 110 allows the terminal apparatus 100 and an external apparatus to communicate with each other. In particular, the communication unit 110 may transmit a card information transmitting service registration request including identification information of a card information transmitting service requested card and user identification information input from the user to a card information transmitting service providing server 600. Further, when a card transaction is performed in a merchant by using the card registered in the card information transmitting service, the communication unit 110 may receive card information from the card information transmitting service providing server 600. Herein, the card information may include location information of the merchant, and is transmitted from a relay server 400 that relays an approval response to the card transaction between a card acquirer server 300 and a card issuer server 500 to the card information transmitting service providing server 600 to be transmitted to the terminal apparatus 100.

A detection unit 120 may detect a notification providing mode set in the terminal apparatus 100 in association with the card information transmitting service. Herein, the notification providing mode may include at least one of a regional notification providing mode, a distance notification providing mode, an amount-of-money notification providing mode, and a card loan mode. The notification providing mode may be set by the user through a mode selection UI screen displayed by executing ‘a card information transmitting service application’.

The display unit 130 serves to display a screen.

Herein, the display unit 130 may be implemented by at least one of a liquid crystal display, a thin film transistor liquid crystal display, an organic light emitting diode, a flexible display, a 3D display, and a transparent display.

The storage unit 140 serves to store various data and programs required for an operation of the terminal apparatus 100. In particular, the storage unit 140 may store the ‘card information transmitting service application’ and a transaction details management service or transaction position display service application which interworks therewith.

Herein, the storage unit 140 may be implemented by embedded storage devices such as a random access memory (RAM), a flash memory, a read only memory (ROM), an erasable programmable ROM

(EPROM), an electrically erasable and programmable ROM (EEPROM), a register, a hard disk, a removable disk, a memory card, and the like, and removable storage devices such as a USB memory, and the like.

The input unit 160 receives a user input in the terminal apparatus 100.

Herein, the input unit 160 may be implemented by using at least one of various button types, a touch sensor that receives a touch input in the display unit 130, a proximity sensor that receives a motion which approaches the surface of the display unit 130 without direct connection to the surface of the display unit 130, and a microphone that receives a voice input of the user. However, the input unit 160 is not limited thereto and may be implemented by any type that is capable of receiving the user input.

The control unit 150 controls an overall operation of the terminal apparatus 100. In detail, the control unit 150 may control all or some of the communication unit 110, the detection unit 120, the display unit 130, and the storage unit 140 in association with “the card information transmitting service application’ or the applications which interwork therewith.

In particular, the control unit 150 may provide notification b using the merchant location information of the card information received according to the detected notification providing mode. Herein, the notification may be push notification.

In detail, when the notification providing mode detected by the detection unit 120 includes the regional notification providing mode, the control unit 150 may provide notification by considering whether the location information of the merchant is a predetermined region. Herein, the region setting may be received from the user of the terminal apparatus 100. As one example, when push notification is OFF in Korea and push notification is ON in other nations, the control unit 150 may provide the push notification only when the location information of the merchant is not Korea.

Further, when the notification providing mode detected by the detection unit 120 includes the distance notification providing mode, in the case where the control unit 150 uses a GPS module provided in the terminal apparatus 100 or the terminal apparatus 100 uses Wi-Fi, location information of the terminal apparatus 100 may be acquired by using connected access point (AP) information. In addition, the control unit 150 may provide the notification only when a distance difference using the location information of the merchant and the location information of the terminal apparatus is equal to or more than a predetermined distance. Herein, the distance difference setting may be received from the user of the terminal apparatus 100. As one example, when the predetermined distance difference is 100 M, the control unit 150 may provide push notification including the card information only when a distance difference calculated by using the location information of the merchant and the location information of the terminal apparatus is equal to or more than 100 M.

Further, when the notification providing mode detected by the detection unit 120 includes the card loan mode, the control unit 150 may provide notification whenever the card transaction is performed by using the card registered in the card information transmitting service.

In addition, when the notification providing mode detected by the detection unit 120 includes the amount-of-money notification providing mode, the control unit 150 may provide notification only when the transaction debit by the card transaction is equal to or more than a predetermined amount of money. Herein, the transaction debit setting may be received from the user of the terminal apparatus 100. As one example, when the predetermined transaction debit is 100,000, the control unit 150 may provide card information notification only when the card transaction using the card registered in the card information transmitting service is equal to or more than 100,000.

According to the exemplary embodiment of the present invention, notification associated with the card information transmitting service is provided to the terminal apparatus, and as a result, the card information based on the position of the user of the terminal apparatus 100 and the position of the merchant may be provided and various services capable of improving user convenience may be provided.

Further, damage to customer's card usage may be prevented by preventing the card from being illegally used in domestics or overseas through copying or losing of the card.

In addition, only when a predetermined condition is met, the terminal apparatus provides the notification associated with the card information transmitting service to set existing spam notification to be removed or notification to be conditionally received.

Meanwhile, according to another exemplary embodiment of the present invention, when an anti-theft service is executed, the terminal apparatus 100 may provide the push notification based on the card information. When the provided push notification is selected through the input unit 160, the control unit 150 may control the display unit 130 to display at least one of the position of a merchant where the card transaction is made, a contact number of the merchant, a contact number of a card issuer, a contact number of a police station around the merchant, and the position of the terminal apparatus. Herein, the position of the merchant and the position of the terminal apparatus may be displayed on a map image. Further, when the contact number of the merchant, the contact number of the card issuer, and the contact number of the police station around the merchant are selected through the input unit 160, transmission may be immediately performed to phone numbers corresponding to the contact numbers.

According to the exemplary embodiment of the present invention, the terminal apparatus 100 in which the anti-theft service is executed displays at least one of the position of the merchant where the card transaction is performed, the contact number of the merchant, the contact number of the card issuer, the contact number of the police station around the merchant, and the position of the terminal apparatus to easily prevent the card from being illegally used in domestics or overseas through the copying or losing of the card and help a subject who illegally uses the card being arrested.

Meanwhile, when a predetermined time elapses after the push notification is provided by the anti-theft service, the control unit 150 may automatically request suspending the card used in the card transaction. In detail, when the predetermined time elapses after the push notification is provided, the control unit 150 may transmit the suspension request of the card used in the card transaction, and as a result, the card issuer server 500 may suspend the card used in the card transaction. In addition, the card issuer server 500 may disapprove the card transaction and transmit a disapproval response to the card transaction a merchant-side transaction terminal 200 through the relay server 400 and the card acquirer server 300.

According to the exemplary embodiment of the present invention, when the predetermined time elapses after the anti-theft service notification based on the card information is provided, the terminal apparatus requests automatically suspending the card use din the card transaction, and as a result, damage to customer's using the card may be prevented even when the customer may not verify the notification.

Meanwhile, the user of the terminal apparatus 100 may verify the notification and decide whether the transaction is approved through his/her own terminal apparatus 100. When the transaction is approved, the terminal apparatus 100 may transmit a transaction approval response to the card issuer server 500. Meanwhile, the card issuer server 500 may examine whether the transaction is approved by using the transaction information received from the relay server 400 when the transaction approval response is received from the customer terminal apparatus 100.

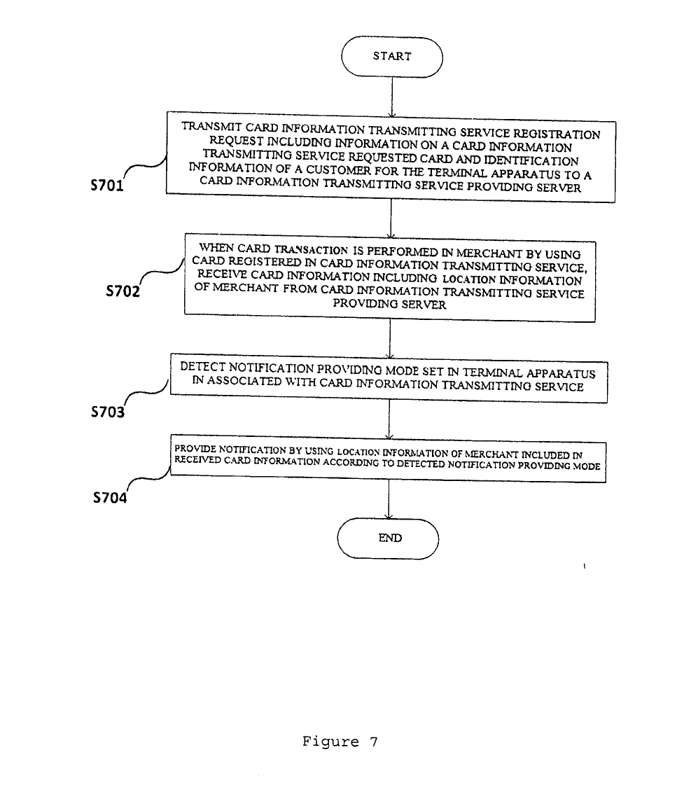

FIG. 7 is a flowchart, in detail, illustrating a method for providing a card information transmitting service of the terminal apparatus according to the exemplary embodiment of the present invention. Referring to FIG. 7, first, a card information transmitting service registration request including information on a card information transmitting service requested card and identification information of a customer for the terminal apparatus may be transmitted to a card information transmitting service providing server (S701).

In addition, when a card transaction is performed in a merchant by using a card registered in a card information transmitting service, card information including location information of the merchant may be received from the card information transmitting service providing server (S702). Herein, in the receiving step (S702), the card information including the location information of the merchant transmitted from a relay server that relays an approval response to the card transaction to the card information transmitting service providing server between a card acquirer server and a card issuer server may be received.

In addition, the terminal apparatus may detect a notification providing mode set in the terminal apparatus in associated with the card information transmitting service (S703). Herein, the notification providing mode may include at least one of a regional notification providing mode, a distance notification providing mode, an amount-of-money notification providing mode, and a card loan mode.

In addition, the terminal apparatus may provide notification by using the location information of the merchant included in the received card information according to the detected notification providing mode.

Meanwhile, the method for providing a card information transmitting service according to various exemplary embodiments of the present invention is implemented by an installation data format to be executed in the terminal apparatus to be provided to respective servers or apparatuses while the method is stored in a non-transitory computer readable medium. As a result, the terminal apparatus 100 accesses the server or apparatus to download the installation data.

The non-transitory computer readable medium means not a medium that stores data during a short instance, such as a register, a cache, a memory, or the like but a medium that semipermanently stores data and is readable by the apparatus. In detail, the aforementioned various applications or programs can be stored in the non-transitory computer readable medium such as a CD, a DVD, a hard disk, a blu-ray disk, a USB, a memory card, a ROM, or the like to be provided.

In addition, preferred exemplary embodiments of the present invention have been illustrated and described above, but the present invention is not limited to the above-described specific embodiment, it is obvious d that various modification may be made by those skilled in the art, to which the present invention pertains without departing from the gist of the present invention, which is claimed in the claims, and such modified embodiments should not be individually understood from the technical spirit or prospect of the present invention.

### DESCRIPTION OF REFERENCE NUMERALS AND SYMBOLS

100: Terminal apparatus
110: Communication unit
120: Detection unit
130: Display unit
140: Storage unit
150: Storage unit
200: Merchant transaction terminal
300: Card acquirer server
400: Relay server
500: Card issuer server
600: Card information transmitting service providing server
610: Communication unit
620: Storage unit
630: Control unit

What is claimed is:

1. A method for providing a card information transmitting service by a server, the method comprising:
receiving a card information transmitting service registration request of a customer;
registering card information of a transmitting service requested card included in the request and identification information of the customer in the request;
receiving, when card identification information included in transaction information by a card transaction in a merchant matches the card information of the transmitting service requested card, identification information of the merchant and the card identification information in the transaction information from a relay server that relays an approval response to the card transaction; and
transmitting merchant location information corresponding to the merchant identification information to a terminal apparatus of the customer by using customer identification information corresponding to the received card identification information.

2. The method of claim 1, further comprising:
transmitting the card information of the transmitting service requested card to the relay server that relays the approval response to the card transaction between a card acquirer server and a card issuer server.

3. The method of claim 2, wherein:
the relay server
receives transaction information by the card transaction in the merchant from the card acquirer server and transmits the received transaction information to the card issuer server, and
determines whether card identification information included in the transaction information by the card transaction in the merchant matches the card information of the transmitting service requested card, and
in the receiving,
when the card information included in the transaction information by the card transaction in the merchant matches the card information of the transmitting service requested card, the identification information of the merchant and the card identification information included in the transaction information are received from the relay server.

4. A method for providing a card information transmitting service by a terminal apparatus, the method comprising:
receiving, when a card transaction is made in a merchant by using a card registered in the card information transmitting service, card information including location information of the merchant from the card information transmitting service providing server;
detecting a notification providing mode set in the terminal apparatus in association with the card information transmitting service; and
providing notification by using the received card information according to the detected notification providing mode.

5. The method of claim 4, wherein:
the notification providing mode includes at least one of a regional notification providing mode, a distance notification providing mode, an amount-of-money notification providing mode, and a card loan mode.

6. The method of claim 4, further comprising:
transmitting to the card information transmitting service providing server a card information transmitting service registration request including card information of the transmitting service requested card and identification information of a customer for the terminal apparatus.

7. The method of claim 4, wherein:
in the receiving,
the card information transmitted from the card information transmitting service providing server through a relay server that relays an approval response to the card transaction between a card acquirer server and a card issuer server is received.

8. The method of claim 5, wherein the providing comprises:
when the detected notification provide mode includes a regional notification providing mode,
the notification is provided by considering whether location information of the merchant is a predetermined region.

9. The method of claim 5, further comprising:
receiving location information of the terminal apparatus when the detected notification providing mode includes a distance notification providing mode,
wherein in the providing,
the notification is provided only when a distance difference using the location information of the merchant and location information of the terminal apparatus is equal to or more than a predetermined distance difference.

10. The method of claim 5, wherein the providing comprises:
when the detected notification providing mode includes a card loan mode,
the notification is provided whenever the card transaction is performed.

11. The method of claim 5, wherein the providing comprises:
when the detected notification providing mode includes an amount-of-money notification providing mode,
the notification is provided only when a transaction debit by the card transaction is equal to or more than a predetermined amount of money.

12. The method of claim 5, further comprising:
displaying at least one of the position of a merchant where the card transaction is performed, a contact number of the merchant, a contact number of the card issuer, a contact number of a police station around the merchant, and the position of the terminal apparatus when the notification is push notification and the push notification is selected.

13. The method of claim 5, further comprising:
automatically requesting suspending a card used in the card transaction when the notification is the push notification and a predetermined time elapses after the push notification is provided.

14. A server for providing a card information transmitting service, the server comprising:
a communication unit receiving a card information transmitting service registration request of a customer;
a storage unit registering card information of a transmitting service requested card and identification information of the customer included in the request; and
a control unit receiving, when card information included in transaction information by a card transaction in a merchant matches card information of the transmitting servicer requested card, identification information of the merchant and the card identification information from a relay server that relays an approval response to the card transaction, and controlling the communication unit so as to transmit location information of the merchant corresponding to the received identification information of the merchant to a terminal apparatus of the customer by using customer identification information corresponding to the received card identification information.

15. The server of claim 14, wherein:
the control unit controls the communication unit to transmit the card information of the transmitting service requested card to the relay server that relays the approval response to the card transaction between a card acquirer server and a card issuer server.

16. A terminal apparatus for providing a card information transmitting service, the terminal apparatus comprising:
a communication unit receiving, when a card transaction is made in a merchant by using a card registered in the card information transmitting service, card information including location information of the merchant from the card information transmitting service providing server;
a detection unit detecting a notification providing mode set in the terminal apparatus in association with the card information transmitting service; and
a control unit providing notification by using the received location information of the merchant according to the detected notification providing mode.

17. The terminal apparatus of claim 16, wherein:
the notification providing mode includes at least one of a regional notification providing mode, a distance notification providing mode, an amount-of-money notification providing mode, and a card loan mode.

18. The terminal apparatus of claim 16, wherein:
the control unit controls the communication unit to transmit to the card information transmitting service providing server a card information transmitting service registration request including card information of the transmitting service requested car and identification information of a customer for the terminal apparatus.

19. The terminal apparatus of claim 16, wherein:
the control unit provides a transaction details management service based on the card information.

20. The terminal apparatus of claim 16, wherein:
the control unit provides a map service for displaying both a transaction position and a user position corresponding to the transaction position based on the card information.
